(19) United States
(12) Patent Application Publication
(10) Pub. No.: US 2006/0026325 A1
(43) Pub. Date: Feb. 2, 2006

(54) Method for automatically assigning a communication port address and the blade server system thereof

(76) Inventors: Jen-Hsuen Huang, Pate City (TW); Cheng-Hsiang Wu, Tao Yuan Shien (TW)

Correspondence Address: RABIN & Berdo, PC, 1101 14TH STREET, NW, SUITE 500, WASHINGTON, DC, 20005, US

(21) Appl. No.: 11/075,752

(22) Filed: Mar. 10, 2005

(30) Foreign Application Priority Data
Jul. 13, 2004 (TW) 93120913

(51) Int. Cl. G06F 13/00

(52) U.S. Cl. 710/302

(57) ABSTRACT

A method for automatically assigning a communication port address and the blade server system thereof are provided. The blade server system comprises a middle plane and a plurality of hot-swappable devices. The middle plane has a plurality of slots. Each of the hot-swappable devices has a connector coupled to one of the slots. Each of the slots respectively corresponds to a slot ID. A particular hot-swappable device plurality of the hot-swappable devices is received at a particular slot of a plurality of slots. The particular hot-swappable device obtains the corresponding slot ID of the particular slot via the particular connector. The particular hot-swappable device generates a particular communication port address according to the particular slot ID. The particular hot-swappable device further broadcasts the particular communication port address to other hot swap devices already received at the middle plane, and receives the respective communication port address thereof.

This application claims the benefit of Taiwan application Serial No. 93120913, filed Jul. 13, 2004, the subject matter of which is incorporated herein by reference.

### BACKGROUND OF THE INVENTION

1. Field of the Invention

The invention relates in general to a method for automatically assigning a communication port address and the blade server system thereof, and more particularly to a method for automatically assigning a communication port address and a hot-swappable device, wherein the hot-swappable device obtains a corresponding slot identification of the slot via a connector, and the hot-swappable device generates a communication port address via the slot ID.

2. Description of the Related Art

Blade server system 100, the most common server system, comprises a plurality of blade servers 102. The blade server 102 integrates the hardware of a server system including a processor, a memory, and a hard disc etc. into a single motherboard, wherein the chassis, power supplier, keyboard, display and mouse are shared among blade servers 102.

Referring to FIG. 1, a block diagram of a conventional blade server system is shown. The blade server system 100 comprises a blade server 102, a management server 104 and a middle plane 106. During normal operation of the blade server system 100, the blade server 102 can be directly unplugged from or plugged into any slot of the slots 108-1˜108-6, and this is called “hot swap”. The conventional blade server system has an management server 104 for assigning a communication port address to each of the blade servers 102 received at the blade server system or to other modules to facilitate the exchange of data.

However, the conventional method of assigning the communication port address is fixed and unique. When modularization has become the mainstream design, the management server 104 with hot swap function is gradually applied in the blade server system. When the management server 104 is unplugged and replaced by another management server, the another management server may need to re-define all communication port addresses of the blade server, causing difficulties in the management of communication port addresses or the conflicts among communication port addresses to occur. The mechanism of assigning communication port address within the blade server or between other modules would therefore become more difficult and complicated for the management server 104 with hot swap function when the management server 104 is unplugged from the system

### SUMMARY OF THE INVENTION

The invention provides a method for automatically assigning a communication port address and the blade server system thereof capable of resolving the problems and difficulties arising from the assignment of communication port address due to the hot swap function of the management server.

It is therefore an object of the invention to provide a blade server system, comprising a middle plane and a plurality of hot-swappable devices. The middle plane has a plurality of slots which respectively corresponds to a slot ID. The slot ID respectively corresponds to a communication port address. Each of the hot-swappable devices has a connector and a management controller. Each of the hot-swappable devices is coupled to one of the slots via the corresponding connector of the hot-swappable device. After a particular connector of a particular hot-swappable device of the hot-swappable devices is received at a particular slot of the slots, the particular hot-swappable device obtains a corresponding slot ID of the particular slot via the particular connector.

The particular management controller generates a particular communication port address according to a particular slot ID. The particular management controller further broadcasts the particular communication port address to the management controller of respective hot-swappable device already received at the middle plane, and requests the management controller of respective hot-swappable device received at the middle plane to feedback to respective communication port address.

According to another object of the invention, a method for automatically assigning a communication port address applied in a blade server system is provided. The blade server system comprises a middle plane and a plurality of hot-swappable devices. The middle plane has a plurality of slots. Each of the hot-swappable devices has a connector and a management controller, and is coupled to one of the slots via the corresponding connector of the hot-swappable device. The method of the invention is disclosed below. A plurality of slots are respectively assigned to correspond to a slot ID. A particular hot-swappable device of the hot-swappable devices is received at a particular slot, obtains a corresponding slot ID of the particular slot via the corresponding connector of the particular hot-swappable device, and generates a particular communication port address by a particular management controller of the particular hot-swappable device according to the particular slot ID. Lastly, the particular management controller broadcasts the particular communication port address to other management controllers of respective hot-swappable device already received at the middle plane, and requests the management controller of respective hot-swappable device already received at the middle plane to feedback to respective communication port address.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a conventional blade server system;

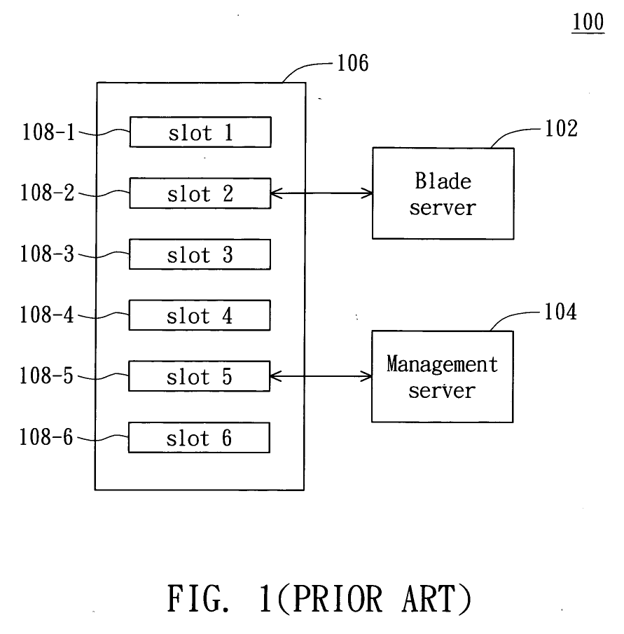

FIG. 2 is a structural diagram of a blade server system adopting the method of automatically assigning a communication port address of the invention;

FIG. 3 is a flowchart of the method for automatically assigning a communication port address according to the invention;

FIG. 4 is a block diagram of a blade server system adopting the method for automatically assigning a communication port address according to a preferred embodiment of the invention; and

FIG. 5 is a coding diagram of the pins of the connector complying with the EPT 246-31300-15 specification.

### DETAILED DESCRIPTION OF THE INVENTION

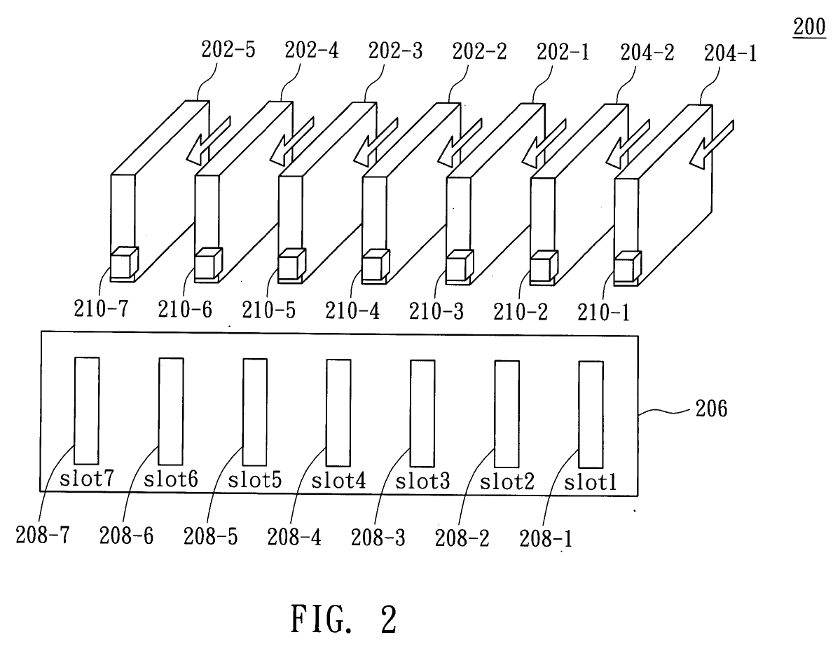

Referring to FIG. 2, a structural diagram of a blade server system adopting the method of automatically assigning a communication port address of the invention is shown. Blade server system 200, which is a hot-swappable system, comprises a middle plane 206 and a plurality of hot-swappable devices. The hot-swappable devices comprise a plurality of blade servers 202-1˜202-5 and a plurality of management servers 204-1˜204-2. The middle plane comprises a plurality of slots 208-1˜208-7. The blade servers 202-1˜202-5 and the management servers 204-1˜204-2 respectively have a plurality of connectors 210-1˜210-7 complying with the EPT 246-31300-15 pin specification. Each of the blade servers 202-1˜202-5 is coupled to one of the slots 208-1˜208-7 such as the slots 208-3˜208-7 via the corresponding EPT 246-31300-15 connectors 210-3˜210-7 of the blade servers 202-1˜202-5. Each of the management servers 204-1˜2 is coupled to one of the slots 208-1˜208-7 such as the slots 208-1˜208-2 via the corresponding EPT 246-31300-15 connectors 210-1˜210-2 of the management servers 204-1˜2.

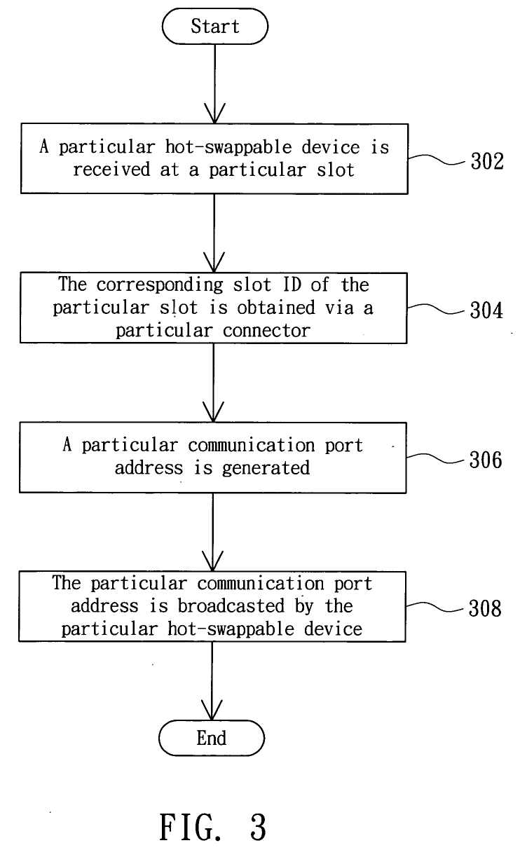

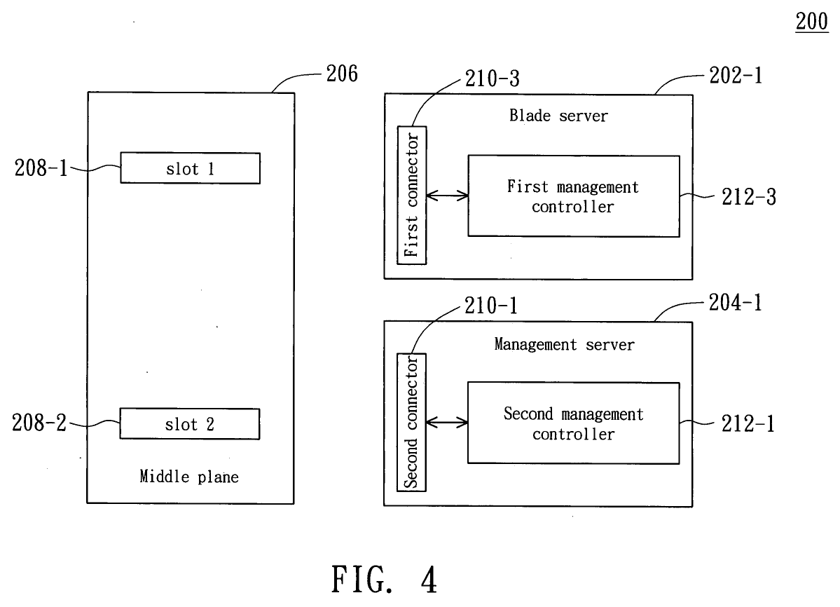

According to the invention, each of the slots 208-1˜208-7 respectively corresponds to a slot ID, and obtains a corresponding slot ID of respective slots 208-1˜208-7 via the four pins of respective EPT 246-31300-15 connectors 210-1˜210-7. Refer to both FIG. 2 and FIG. 3. FIG. 3 is a flowchart of the method for automatically assigning a communication port address according to the invention. In FIG. 3, firstly, the method begins at step 302: a particular hot-swappable device is received at a particular slot. For example, in FIG. 2, the particular hot-swappable device is the blade server 202-1, corresponding to the particular slot 208-3. Next, proceed to step 304: the corresponding slot ID of the particular slot is obtained via a particular connector. That is to say, the blade server 202-1 obtains the particular slot ID corresponding to the particular slot 208-3 via the four pins of the corresponding particular connectors 210-3 of the blade server 202-1. Then, proceed to step 306: a particular communication port address is generated by the particular hot-swappable device according to the particular slot ID. That is to say, the particular management controller 212-3 (refer to FIG. 4) of the blade server 202-1 generates a particular communication port address according to particular slot ID. Lastly, proceed to step 308: the particular communication port address is broadcasted by the particular hot-swappable device to other management controllers of each hot-swappable device already received at the middle plane, requesting the management controller of respective hot-swappable device already received at the middle plane to feedback respective communication port address to the particular hot-swappable device. By doing so, the particular hot-swappable device is able to exchange data with other hot-swappable devices.

Furthermore, in step 304, since the EPT 246-31300-15 connector comprises four pins, and constructs 2⁴ sets of slot ID, i.e., 16 sets of slot ID. Only 7 sets of slot ID are used in the present embodiment. In practice, the slots 208-1˜208-7 can have as many as 16 sets of different slot ID. Therefore, the 16 hot-swappable devices can be used. Therefore, in the present embodiment, the 7 sets of slot ID are respectively assigned to the slots 208-1˜208-7, so that each of the slots 208-1˜208-7 respectively has a different slot ID, enabling the blade server 202-1 to obtain the corresponding slot ID of the particular slot 208-3 via the four pins of the corresponding particular connector 210-3 of the blade server 202-1. In step 306: 16 sets of communication port address corresponding to 16 sets of slot ID are inbuilt in the particular management controller 212-3 of the blade server 202-1. The particular management controller 212-3 generates a corresponding particular communication port address according to the corresponding slot ID of the particular slot 208-3.

Referring to FIG. 4, a block diagram of a blade server system adopting the method for automatically assigning a communication port address according to a preferred embodiment of the invention is shown. A first slot 208-1 and a second slot 208-2 of the middle plane 206 respectively correspond to a first slot ID1 and a second slot ID2. The blade server 202-1, which has a first connector 210-3 and a first management controller 212-3, is received at the first slot 208-1 or the second slot 208-2 via the first connector 210-3. When the blade server 202-1 is received at the first slot 208-1, the blade server 202-1 obtains the corresponding first slot ID1 of the first slot 208-1 via the first connector 210-3. The first management controller 212-3 generates a first communication port address according to the first slot ID1. When the blade server 202-1 is received at the second slot 208-2, the blade server 202-1 obtains the corresponding second slot ID2 of the second slot 208-2 via the first connector 210-3. Besides, the first management controller 212-3 also generates a second communication port address according to the second slot ID2.

Similarly, the management server 204-1, which has a second connector 210-1 and a second management controller 212-1, is received at the first slot 208-1 or the second slot 208-2. After the management server 204-1 is received at the first slot 208-1, the management server 204-1 obtains the corresponding first slot ID1 of the first slot 208-1 via the second connector 210-1. The second management controller 212-1 generates the first communication port address according to the first slot ID1. After the management server 204-1 is received at the second slot 208-2, the management server 204-1 obtains the corresponding second slot ID2 of the second slot 208-2 via the second connector 210-1. The second management controller 212-1 generates the second communication port address according to the second slot ID2.

Therefore, when the management server 204-1 is already received at the first slot 208-1, the management server 204-1 obtains the first communication port address. When the blade server 202-1 is received at the second slot 208-2, the blade server 202-1 obtains the second communication port address. Furthermore, the first management controller 212-3 of the blade server 202-1 broadcasts the second communication port address to the management server 204-1 already received at the first slot 208-1, and the second management controller 212-1 of the management server 204-1 feedbacks the first communication port address to the blade server 202-1. To the contrary, when the blade server 202-1 is already received at the first slot 208-1, the blade server 202-1 obtains the first communication port address. When the management server 204-1 is received at the second slot 208-2, the management server 204-1 obtains the second communication port address. Furthermore, the second management controller 212-1 of the management server 204-1 broadcasts the second communication port address to the blade server 202-1 already received at the first slot 208-1, and the first management controller 212-3 of the blade server 202-1 feedbacks the first communication port address to the management server 204-1. Therefore, no matter the blade server 202-1 or the management server 204-1 is received at one of the slots 208-1˜208-7, the corresponding slot IDs of the slots 208-1˜208-7 can be obtained via the four pins of the corresponding connector 210-3. The corresponding slot ID of the communication port address can be obtained via the corresponding 16 sets of communication port address of the 16 sets of slot ID in-built in respective management controllers 212-3 and 212-1.

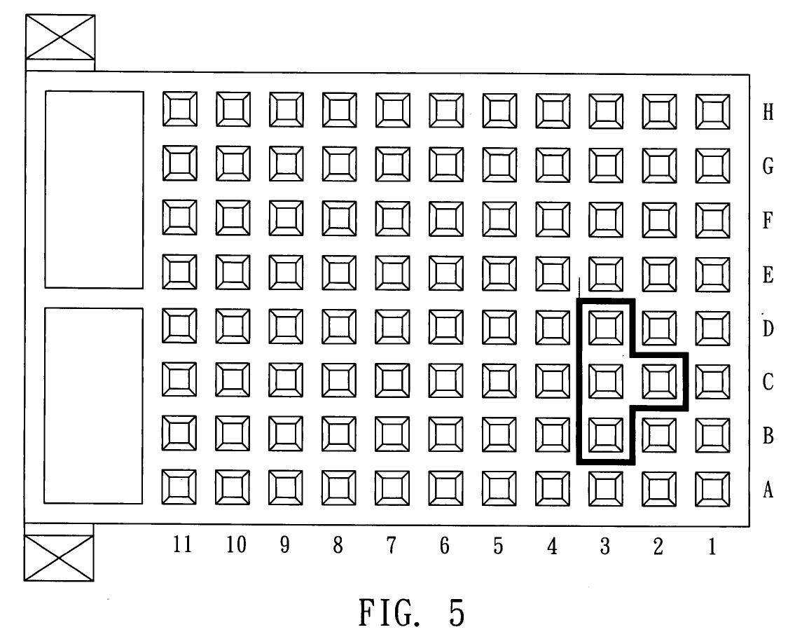

Next, referring to FIG. 5, a coding diagram of the pins of the connector complying with the EPT 246-31300-15 specification is shown. The invention obtains 16 sets of communication port address of the 16 sets of slot via the four pins of the EPT 246-31300-15 connector, which are highlighted in FIG. 5. The joint angle distribution is defined as follows: the y-axis code is A, B, C, D, E; F, G, and H, the x-axis code is 1, 2, 3, 4, 5, 6, 7, 8, 9, 10, and 11, while the four pins of the invention are the pins of EPT 246-31300-15 connector with the code B3, C2, C3 and D3.

In the blade server system adopting the method for automatically assigning a communication port address of the invention, when any of the slots is received at one of the hot-swappable devices, the slot ID is obtained and a communication port address corresponding to the identification (slot ID) is generated. The newly received hot-swappable device broadcasts its own communication port address to other hot-swappable devices received at the middle plane and receive the communication port address of respective hot-swappable device already received at the middle plane, so that the newly received hot-swappable device can exchange or process data with other hot-swappable devices.

The blade server system adopting the method for automatically assigning a communication port address disclosed in above embodiment obtains corresponding slot IDs of respective slots via the four pins of the EPT 246-31300-15 connector, so that a plurality of blade servers or a plurality of management servers disposed at the same blade server system are capable of automatically assigning a communication port address. The invention can resolve the problems and difficulties arising from the assignment of communication port address due to the hot swap function of the management server.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A hot-swappable system with the function of automatically assigning a communication port address, wherein the system comprises:
a middle plane having a plurality of slots, wherein the slots respectively correspond to a slot ID, which corresponds to a communication port address respectively; and
a plurality of hot-swappable devices, wherein each of the hot-swappable devices, which has a connector and a management controller, is coupled to one of the slots via the corresponding connector of the hot-swappable device;
after a particular hot-swappable device of the hot-swappable devices is received at a particular slot of the slots via a particular connector of the hot-swappable device, the particular hot-swappable device obtains a corresponding particular slot ID of the particular slot via the particular connector, a particular management controller of the particular hot-swappable device generates a particular communication port address according to the particular slot ID, the particular management controller further broadcasts the particular communication port address to other management controllers of respective hot-swappable device already received at the middle plane, and requests the management controller of respective hot-swappable device already received at the middle plane to feedback respective communication port address thereof to the particular hot-swappable device.

2. The system according to claim 1, the hot-swappable system comprises a blade server system.

3. The system according to claim 2, the hot-swappable devices comprises a blade server and a management server.

4. The system according to claim 3, wherein the connectors is a connector complying with the EPT 246-31300-15 specification.

5. The system according to claim 4, wherein the definition of the pin of the connector is as follows: the y-axis code is A, B, C, D, E, F, G, and H, and the x-axis code is 1, 2, 3, 4, 5, 6, 7, 8, 9, 10, and 11.

6. The system according to claim 5, wherein the connector further comprises four pins whose respective codes are IB3, C2, C3 and D3, the particular hot-swappable device obtains the particular slot ID via the four pins of the particular connector.

7. A blade server system having a middle plane, wherein the middle plane at least comprises a first slot and a second slot, both of which respectively correspond to a first slot ID and a second slot ID, the blade server system at least comprises:
a blade server comprising a first connector and a first management controller, wherein when the blade server is received at the first slot via the first connector, the first management controller generates a first communication port address corresponding to the first slot ID, or when the blade server is received at the second slot via the first connector, the first management controller generates a corresponding second communication port address of the second slot ID; and
an management server comprising a second connector and a second management controller, wherein when the management server is received at the first slot via the second connector, the second management controller generates a corresponding first communication port address of the first slot ID, or when the management server is received at the second slot via the second connector, the second management controller generates a corresponding second communication port address of the second slot ID.

8. The system according to claim 7, wherein, when the management server is already received at the first slot, the management server has the first communication port address, and when the blade server is received at the second slot, the blade server obtains the second communication port address, furthermore, the first management controller of the blade server broadcasts the second communication port address to the second management controller of the management server already received at the first slot, and the second management controller feedbacks the first communication port address to the first management controller of the blade server.

9. The system according to claim 8, wherein, when the blade server is already received at the first slot, the blade server has the first communication port address, and when the management server is received at the second slot, the management server obtains the second communication port address, furthermore, the second management controller of the management server broadcasts the second communication port address to the first management controller of the blade server already received at the first slot, and the first management controller feedbacks the first communication port address to the second management controller of the management server.

10. The system according to claim 9, wherein the blade server and the management server has hot swap function.

11. The system according to claim 10, wherein both the first connector and the second connector are a connector complying with the EPT 246-31300-15 specification.

12. The system according to claim 11, wherein the definition of the pin of the connector is as follows: the y-axis code is A, B, C, D, E, F, G, and H, and the x-axis code is 1, 2, 3, 4, 5, 6, 7, 8, 9, 10, and 11.

13. The system according to claim 12, wherein the first connector further comprises four pins whose respective codes are B3, C2, C3 and D3, and the blade server obtains the first slot ID or the second slot ID via the four pins of the first connector for the first management controller to generate the first communication port address or the second communication port address.

14. The system according to claim 13, wherein the second connector further comprises four pins whose respective codes are B3, C2, C3 and D3, and the management server obtains the first slot ID or the second slot ID via four pins of the second connector for the second management controller to generate the first communication port address or the second communication port address.

15. A method for automatically assigning a communication port address applied in a blade server system comprising a middle plane and a plurality of hot-swappable devices, wherein the middle plane has a plurality of slots, and each of the hot-swappable devices, which has a connector and a management controller, is coupled to one of the slots via the corresponding connector of the hot-swappable device, the method comprises:
assigning the respective slots to correspond to a slot ID;
inserting a particular hot-swappable device of the hot-swappable devices into a particular slot of the slots, and obtaining a corresponding slot ID of the particular slot via the corresponding connector of the particular hot-swappable device;
using a particular management controller of the particular hot-swappable device to generate a particular communication port address according to the particular slot ID; and
using the particular management controller to broadcast the particular communication port address to other management controllers of respective hot-swappable device already received at the middle plane, and request the management controllers of respective hot-swappable device already received at the middle plane to feedback respective communication port address.

16. The method according to claim 15, wherein the hot-swappable devices comprises a blade server and a management server.

17. The method according to claim 16, wherein the connectors are a connector complying with the EPT 246-31300-15 specification.

18. The method according to claim 17, wherein the definition of the pin of the connector is as follows: the y-axis code is A, B, C, D, E, F, G, and H, and the x-axis code is 1, 2, 3, 4, 5, 6, 7, 8, 9, 10, and 11.

19. The method according to claim 18, wherein the connector further comprises four pins whose respective codes are B3, C2, C3 and D3, each of the hot-swappable devices obtains the corresponding slot ID of respective slot via the corresponding four pins of the hot-swappable device.
